(19) United States
(12) Patent Application Publication
(10) Pub. No.: US 2026/0359332 A1
(43) Pub. Date: Nov. 12, 2026

(54) METHOD, APPARATUS, DEVICE AND STORAGE MEDIUM FOR INFORMATION INTERACTION

(71) Applicant: Beijing Youzhuju Network Technology Co., Ltd., Pinggu District, Beijing (CN)

(72) Inventors: Binghong Li, Beijing (CN); Zhijian Li, Beijing (CN); Shijiao Zhang, Beijing (CN); Jian Gong, Beijing (CN)

(21) Appl. No.: 19/462,139

(22) Filed: Jan. 28, 2026

(30) Foreign Application Priority Data
May 9, 2025 (CN) 202510600680.9

(51) Int. Cl. G06F 16/3332; G06F 3/0484; G06F 16/338

(52) U.S. Cl. CPC G06F 16/3334; G06F 3/0484; G06F 16/338

(57) ABSTRACT

A method, an apparatus, a device, and a storage medium for information interaction are provided. The method includes: obtaining object information to be presented in a detail interface of an object; obtaining auxiliary information related to the object based on the object information; and presenting, in a predetermined area of the detail interface of the object, the auxiliary information and a generation identifier for the auxiliary information indicating that the auxiliary information is automatically generated.

### CROSS-REFERENCE

This application claims the benefit of CN Patent Application No. 202510600680.9, filed on May 9, 2025, entitled "METHOD, APPARATUS, DEVICE AND STORAGE MEDIUM FOR INFORMATION INTERACTION", which is hereby incorporated by reference in its entirety.

### FIELD

Example embodiments of the present disclosure generally relate to the field of computers, and in particular, to a method, an apparatus, an electronic device, a computer-readable storage medium, and a computer program product for information interaction.

### BACKGROUND

With the rapid development of information technologies, various terminal devices may provide people with various services in aspects such as work and life. The terminal devices may provide users with interactive functions to assist the users in performing corresponding interaction operations on multimedia data. In some scenarios, a merchant may need to show some information about an object (for example, a product) to a user to assist the user in knowing the object. Therefore, it is expected to provide the user with richer information related to the object.

### SUMMARY

In a first aspect of the present disclosure, a method for information interaction is provided, including: obtaining object information to be presented in a detail interface of an object; obtaining auxiliary information related to the object based on the object information; and presenting, in a predetermined area of the detail interface of the object, the auxiliary information and a generation identifier for the auxiliary information indicating that the auxiliary information is automatically generated.

In a second aspect of the present disclosure, an apparatus for information interaction is provided, including: an object information obtaining module configured to obtain object information to be presented in a detail interface of an object; an auxiliary information obtaining module configured to obtain auxiliary information related to the object based on the object information; and an auxiliary information presenting module configured to present, in a predetermined area of the detail interface of the object, the auxiliary information and a generation identifier for the auxiliary information indicating that the auxiliary information is automatically generated.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium stores computer-executable instructions executable by a processor to implement the method of the first aspect.

According to a fifth aspect of the present disclosure, a computer program product is provided, including computer-executable instructions, where the computer-executable instructions, when executed by a processor, implement the method of the first aspect.

It would be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments of the present disclosure may be implemented;

FIG. 2 illustrates a flowchart of an example process for information interaction according to some embodiments of the present disclosure;

FIGS. 3A-3E illustrate schematic diagrams of example interfaces for information interaction according to some embodiments of the present disclosure;

FIG. 4 illustrates a flowchart of a process for information interaction according to some embodiments of the present disclosure;

FIG. 5 illustrates a block diagram of an apparatus for information interaction according to some embodiments of the present disclosure; and

FIG. 6 illustrates a block diagram of an electronic device capable of implementing one or more embodiments of the present disclosure.

### DETAILED DESCRIPTION

The embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein; on the contrary, these embodiments are provided for a more thorough and complete understanding of the present disclosure. It would be appreciated that the drawings and embodiments of the present disclosure are only used for illustrative purposes, and are not used to limit the protection scope of the present disclosure.

In the description of the embodiments of the present disclosure, the term "include/comprise" and similar terms thereof should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other definitions, either explicit or implicit, may also be included below.

Herein, unless explicitly stated, performing a step "in response to A" does not mean that the step is performed immediately after "A", but may include one or more intermediate steps.

It may be understood that the data involved in the technical solution (including but not limited to the data itself, acquisition or use of the data) shall comply with requirements of corresponding laws, regulations and related provisions.

It may be understood that before using the technical solutions disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, in response to receiving an active request from a user, prompt information is sent to the user to clearly prompt the user that the requested operation will require access to and use of the user’s personal information, so that the user may independently choose, based on the prompt information, whether to provide the personal information to software or hardware, such as an electronic device, an application, a server or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to "agree" or "disagree" to provide the personal information to the electronic device.

It may be understood that the above process of notifying and obtaining user authorization is only illustrative and does not limit the implementation of the present disclosure, and other methods that satisfy the relevant laws and regulations may also be applied to the implementations of the present disclosure.

As used herein, the term "model" may learn the correlation between corresponding inputs and outputs from training data, so that after the training is completed, the corresponding outputs may be generated for given inputs. The generation of the model may be based on machine learning techniques. Deep Learning is a machine learning algorithm that uses multiple layers of processing units to process inputs and provide corresponding outputs. A neural network model is an example of a model based on deep learning. Herein, a "model" may also be referred to as a "machine learning model", a "learning model", a "machine learning network" or a "learning network", which terms are used interchangeably herein.

In the present disclosure, "triggering" refers to one or more interaction operations of a user on a terminal device. Further, these interaction operations may be triggered within the same user interface/pop-up window, or may be triggered within different user interfaces/pop-up windows. The present disclosure is not limited in this regard.

The example embodiments of the present disclosure are described below with reference to the drawings.

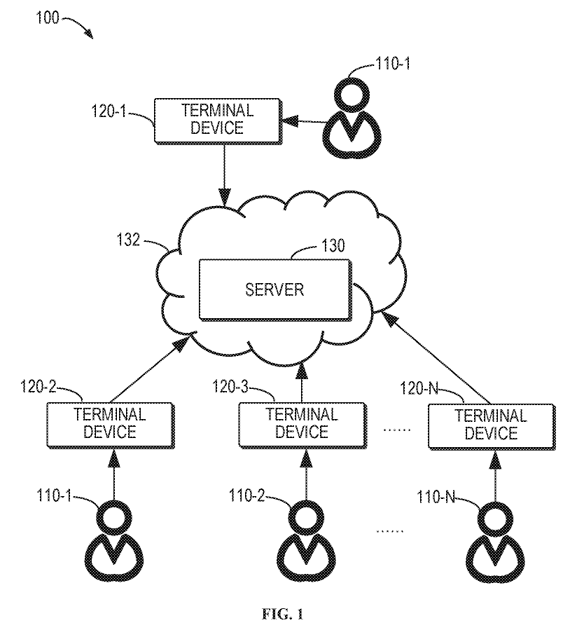

FIG. 1 illustrates a schematic diagram of an example environment 100 in which the embodiments of the present disclosure may be implemented. In the environment 100, one or more users 110-1, 110-2, 110-3, ..., 110-N may perform interaction operations associated with an object, such as browsing the object, viewing the object, purchasing the object, collecting the object, and so on, through their associated terminal devices 120-1, 120-2, ..., 120-N, respectively. For the convenience of discussion, the users 110-1, 110-2, ..., 110-N may be collectively or individually referred to as the user 110, and the terminal devices 120-1, 120-2, ..., 120-N may be collectively or individually referred to as the terminal device 120. Herein, the object may be a physical or virtual object, such as a physical or virtual product, a service, an electronic work, etc. In the following embodiments, for the convenience of discussion, an online product is taken as an example of the object for description.

In some embodiments, the user 110 may also be referred to as an object publisher, for example. That is, the user 110 may publish an object for other users to perform interaction operations related to the object. In some embodiments, the user 110 (for example, the object publisher) may publish the object via the corresponding terminal device 120. After receiving the object published by the user 110 (for example, the object publisher), the server 130 may send the object to the terminal devices 120 corresponding to other users, and the terminal devices 120 present the object to the other users. In some embodiments, when sending the object to each terminal device 120, the server 130 may send both the object information of the object and the generated auxiliary information related to the object to the terminal device 120. The terminal device 120 may present the object, the object information of the object, and the auxiliary information associated with the object in an interface for the user 110 to know the object.

In some embodiments, among all the users 110, one or more of the users, such as the user 110-1, may publish objects through the associated terminal device 120-1. In some embodiments, the user 110-1 may include a user corresponding to an e-commerce store. In some embodiments, the users who perform information interaction may include the user 110-1 and one or more other users 110-2 to 110-N. The users 110-2 to 110-N may be consumers.

In some embodiments, the terminal devices 120 may be respectively installed with applications that may provide information interaction services, or may access websites that may provide information interaction services. The user 110 may operate the terminal device 120 to access a corresponding application or website. Accordingly, the terminal device 120 may present corresponding pages such as an object presentation page, an information presentation page, a search page, and so on.

In some embodiments, the terminal device 120 may also communicate with the server 130 over a network 132 to enable the provision of query services. The server 130 may provide functions such as management, configuration and maintenance of the application or website. In some embodiments, if the server 130 receives an object uploaded by the user 110 (for example, the object publisher) via the terminal device 120, the server 130 may present, in an interface, the object information of the object and the auxiliary information related to the object. In some embodiments, the server 130 may invoke a machine learning model to generate the auxiliary information related to the object, so as to provide the user 110 with richer information related to the object.

The terminal device 120 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination of the foregoing, including the accessories and peripherals of these devices or any combination thereof. In some embodiments, the terminal device 120 may also support any type of user-specific interface (such as "wearable" circuitry, etc.).

The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server such as a mainframe, an edge computing node, a computing device in a cloud environment, and so on. The server 130 may provide back-end services for applications in the terminal device 120 that support queries.

It would be appreciated that the structure and function of each element in the environment 100 are described for illustrative purposes only, without suggesting any limitation to the scope of the present disclosure.

As briefly mentioned above, a merchant may need to show some information about an object (for example, a product) to a user to assist the user in knowing the object. Conventionally, for an object published by a merchant, the terminal device 120 may present object information corresponding to the object in an interface. In some scenarios, the terminal device 120 may present product information (such as an image of the product, a name of the product, and so on) uploaded by the merchant in the interface. In such a scenario, the user cannot fully know the product due to the limited product information provided by the merchant. Further, the capability of maintaining the basic information of the product is poor, for example, the attribute information of the product is lacking, and the evaluation information of the product is also lacking for a newly published product. Therefore, the above solution is not conducive for the user to know the product, resulting in a poor user experience.

According to some embodiments of the present disclosure, an improved solution for information interaction is proposed. According to the solution of the embodiments of the present disclosure, object information to be presented in a detail interface of an object is obtained. Further, auxiliary information related to the object is obtained based on the object information. Accordingly, the auxiliary information and a generation identifier for the auxiliary information are presented in a predetermined area of the detail interface of the object, the generation identifier indicating that the auxiliary information is automatically generated.

In this way, the auxiliary information of the object may be automatically generated and presented according to the object information of the object, thereby the richness of information presented in the detail interface may be improved. Further, by presenting the object information and the automatically generated auxiliary information in the interface, the attention of the user may be attracted, the user may know the object more comprehensively, and the user may be promoted to perform the next operation related to the object. This is particularly beneficial in the case that the provision of the object information is insufficient. On the other hand, it may also save the information supply cost of the publisher of the object (for example, an e-commerce user corresponding to an online product), and make up for the lack of information supply.

Some example embodiments of the present disclosure will be described in detail below with continued reference to the drawings. It would be appreciated that the pages shown in the drawings are only examples, and there may actually be various page designs. Each graphic element in the page may have different layouts and different visual representations, one or more of the elements may be omitted or replaced, and there may also be one or more other elements. The embodiments of the present disclosure are not limited in this regard. In addition, in the following, the example embodiments will be described mainly with respect to the terminal device 120. It would be appreciated that the actions described with respect to the terminal device 120 may also be performed by an application on the terminal device 120, or may be performed by the application in cooperation with its server (for example, the server 130).

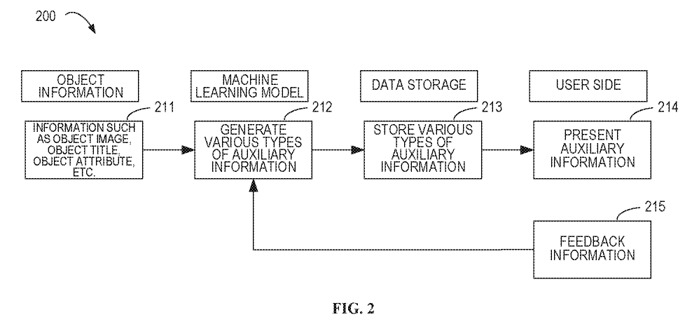

The process for information interaction according to the present disclosure will be described below with reference to FIG. 2. FIG. 2 illustrates a flowchart of an example process 200 for information interaction according to some embodiments of the present disclosure. For the convenience of discussion, these embodiments will be described with reference to the environment 100 of FIG. 1. For the convenience of discussion, it is taken as an example that these embodiments are implemented in the terminal device 120 of FIG. 1, although it should be understood that some operations in these embodiments may also be performed or assisted by the server 130.

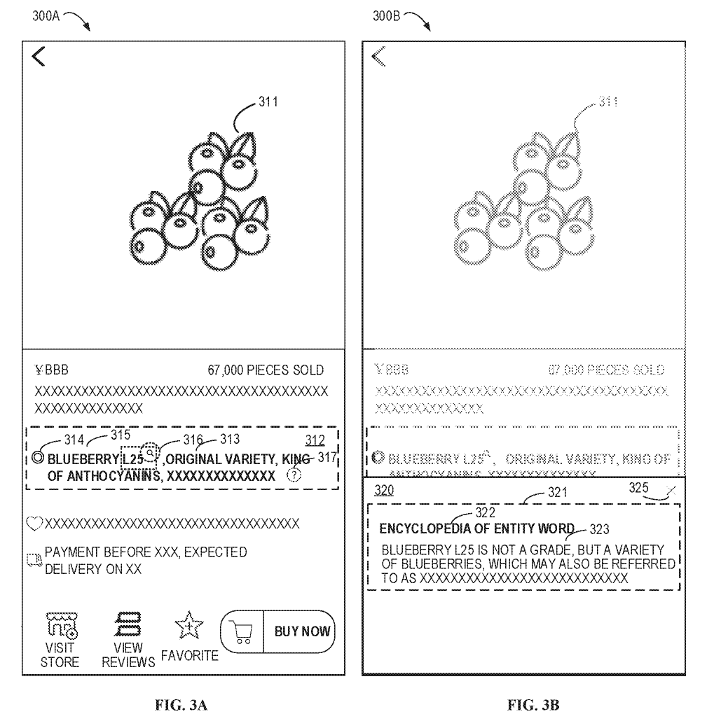

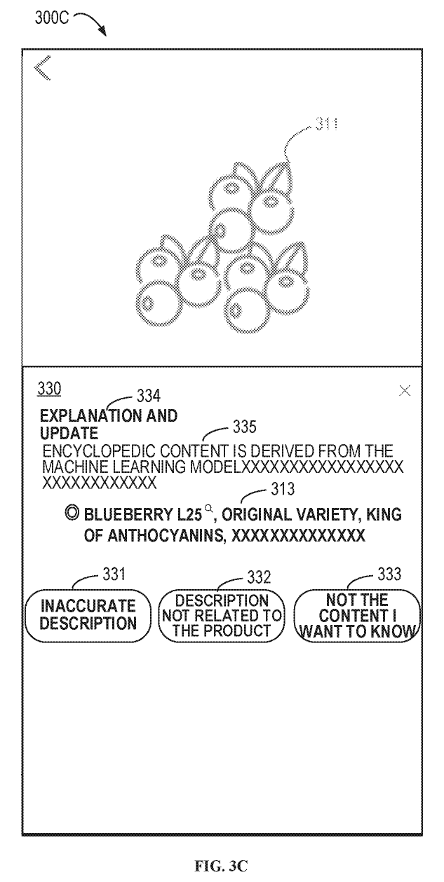

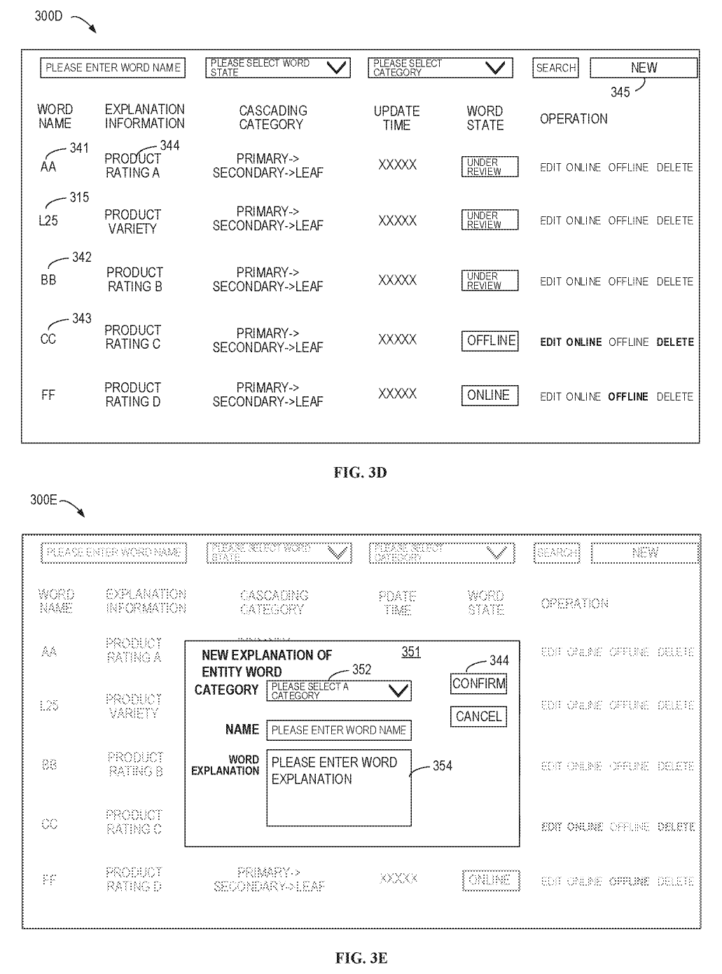

In the discussion of the example process 200, some embodiments of the present disclosure for information interaction will be explained in conjunction with FIGS. 3A-3E for a better understanding. FIGS. 3A-3E illustrate schematic diagrams of example interfaces 300A to 300E for information interaction according to some embodiments of the present disclosure.

Herein, the terminal device 120 may present multiple objects in an interface, and these objects may be uploaded by different users 110 (for example, merchants). The user 110 (for example, a consumer) may perform operations related to the objects, such as purchasing, browsing, viewing, collecting, searching, and so on, via the terminal device 120. In the embodiments of the present disclosure, the terminal device 120 may present the object information of the object and the auxiliary information related to the object in the interface to improve the richness of the information of the object, thereby helping the user 110 know the object more comprehensively. How to present the auxiliary information related to the object in the interface will be described in detail below.

In the embodiments of the present disclosure, the terminal device 120 obtains object information to be presented in a detail interface of an object. As shown in the example process 200 of FIG. 2, at block 211, the terminal device 120 may obtain object information to be presented in a detail interface of an object (for example, a product). In some examples, the object may be various types of products, such as food (such as fruits and vegetables), clothing, home textiles, electronic products, and so on. These are only examples, and the present disclosure is not limited thereto. In some embodiments, the object information may include an image of the object, for example, the corresponding information for blueberries may include an image of blueberries. In some embodiments, the object information may include a title of the object, for example, the corresponding information for blueberries may include the title "Blueberries from City A". In some embodiments, the object information may include a description text of the object, for example, the corresponding information for blueberries may include a text describing blueberries. In some embodiments, the object information may include attribute information of the object, for example, the corresponding attribute information for blueberries may include attribute information such as the color, shape and growing environment of the blueberries.

In some embodiments, the object information provided in the detail interface may be provided by an object publisher. For example, in an e-commerce scenario, each online product may have its own detail interface, in which the presented object information may be provided by an operator or a manager of the e-commerce store.

In the embodiments of the present disclosure, the terminal device 120 obtains auxiliary information related to the object information based on the object information for supplementary presentation in the detail interface. Generally, the detail interface of the object is mainly provided to present comprehensive information related to the object, so that the user may know information of the object per se and information related to the obtaining of the object (for example, price, after-sales service, and so on) from the interface. In addition to the object information provided by the object publisher, in the embodiments of the present disclosure, the auxiliary information may supplement the object information already presented in the detail interface.

In some embodiments, the auxiliary information obtained by the terminal device 120 may indicate encyclopedic content associated with the object. The encyclopedic content may include various knowledge in the discipline (for example, literature, geography, nature, and so on) to which the object belongs. The encyclopedic content may help provide a more comprehensive description and introduction of the object. It may be understood that the terminal device 120 may obtain the encyclopedic content related to the object based on the object information of the object. As an example, for blueberries, the terminal device 120 may obtain the encyclopedic content of blueberries according to the information of the blueberries, and the encyclopedic content may provide various introduction information about the blueberries.

In some embodiments, at block 212, the terminal device 120 may automatically generate the auxiliary information related to the object using a machine learning model based on the object information. In some embodiments, the terminal device 120 may use the machine learning model to generate various types of structured auxiliary information (for example, object knowledge in different aspects) based on the object information. The machine learning model used may include a content generation model, which may generate expected output content based on the input information and generation requirements. For example, the object information and a generation requirement indicating the generation of encyclopedic content of the object may be provided to the machine learning model, and the auxiliary information may be determined based on the output content. In some embodiments, the machine learning model may include at least a language model (LM). In some embodiments, the machine learning model based on the language model may receive model input in a text modality (for example, a natural language and/or a machine language) and/or in a non-text modality (for example, an image, a voice, a video, etc.), and obtain a corresponding model output according to the model input and a prompt. The prompt here may indicate the generation requirement, thereby guiding the machine learning model to generate the expected auxiliary information.

At block 213, the auxiliary information generated according to the object information may be stored for presenting the auxiliary information corresponding to the object in the detail interface of the object. In other words, the generation of the auxiliary information may be performed in advance. In some embodiments, for the object information uploaded by the user 110 (for example, the object publisher), the terminal device 120 may send the object and the object information of the object to the server 130. The server 130 may invoke the machine learning model to generate the auxiliary information associated with the object based on the object information. Subsequently, the server 130 may send the auxiliary information corresponding to the object to the terminal device 120 for presentation in response to a presentation request for the detail interface.

In the embodiments of the present disclosure, the terminal device 120 may present the auxiliary information and a generation identifier for the auxiliary information in a predetermined area of the detail interface of the object. In some embodiments, the generation identifier indicates that the auxiliary information is automatically generated. At block 214, when the terminal device 120 receives that the user 110 (for example, a consumer) views the detail interface of the object, the terminal device 120 may present the auxiliary information generated via the machine learning model in the detail interface. For ease of understanding, the object 311 (for example, blueberries) will be discussed below as an example. This is only illustrative and may be any other appropriate object.

As an example, referring to the example interface 300A shown in FIG. 3A, the terminal device 120 may present auxiliary information, such as "Blueberry L25, original variety, king of anthocyanins, XXX" or any other appropriate auxiliary information 313, in a predetermined area 312 of the detail interface 300A. The terminal device 120 may present a generation identifier 314 for the auxiliary information 313 to inform the user 110 that the auxiliary information 313 of the object 311 is automatically generated. That is, the generation identifier 314 may indicate that the auxiliary information 313 is generated by the terminal device 120 using the machine learning model. Therefore, by presenting the auxiliary information associated with the object in the detail interface of the object, the richness of the information of the object may be improved, thereby helping the user know the object more comprehensively.

In some embodiments, the auxiliary information may include an entity word associated with the object. As an example, the auxiliary information 313 may include an entity word 315 associated with the object 311. In some examples, the entity word associated with the object may indicate a word having a specific meaning in the auxiliary information, for example, a noun used to describe the object. In some embodiments, the terminal device 120 may present the entity word in a predetermined visual style. That is, the entity word is presented in a visual style that is different from other parts of the auxiliary information. As an example, referring to FIG. 3A, the terminal device 120 may present the entity word 316 in a prominent visual style. For example, the prominent visual style may include, but is not limited to, a highlighted visual style, a filled visual style, an underlined visual style, and so on. It would be appreciated that this is only an example, and in practice, any other visual style that is different from other parts of the auxiliary information may be configured according to a specific application, so that the user may notice the entity word more easily.

In some embodiments, the terminal device 120 may present a query identifier indicating that the entity word may be queried. Referring to FIG. 3A, the terminal device 120 may present a query identifier 316 associated with the entity word 315 to prompt the user 110 that the entity word 316 may be queried. Herein, the user 110 may trigger the entity word associated with the object to view the explanation information corresponding to the entity word. Herein, triggering may include, but is not limited to, a trigger operation in any appropriate manner, such as clicking, long pressing, and sliding.

As an example, referring to the example interfaces 300A to 300B shown in FIGS. 3A-3B, if the terminal device 120 receives a trigger on the entity word 315, the terminal device 120 may present the explanation information 321 corresponding to the entity word 315. In some embodiments, if the terminal device 120 receives the trigger on the entity word 315, the terminal device 120 may present a panel 320 in an overlay manner in the detail interface 300B of the object 311. Accordingly, the terminal device 120 may present the explanation information 321 of the entity word 315 in the panel 320.

In some embodiments, the explanation information 321 of the entity word 315 may include a title 322, such as "encyclopedic of entity word" or any other appropriate title content. The explanation information 321 of the entity word 315 may include a text 323 for explaining the entity word 315, such as "blueberry L25 is not a grade, but a variety of blueberries XXX" or any other appropriate title content. In addition, the panel 320 may include a closing control 325 to cancel the presentation of the explanation information of the entity word 315 and return to the detail interface 300A of the object 311. Therefore, by presenting the searchable entity word in the auxiliary information, the user may know the meaning of the entity word in time, thereby improving the user experience.

In some embodiments, the terminal device 120 may determine the entity word included in the auxiliary information by comparing the auxiliary information with an entity word library. In some embodiments, the entity word library includes multiple predefined entity words and corresponding explanation information. In some examples, the terminal device 120 may determine the entity word included in the auxiliary information by comparing the words included in the auxiliary information with the entity words in the pre-built entity word library. How to build the entity word library will be described below with continued reference to FIGS. 3D-3E.

As shown in the example interfaces 300D to 300E of FIGS. 3D-3E, the entity word library may include multiple predefined entity words, such as entity words 341, 315, 342, 343, and so on. Each entity word has its corresponding explanation information, for example, the entity word 341 has its corresponding explanation information 344. Each entity word has its corresponding category structure, such as "primary category>secondary category>tertiary category>leaf category" or any other appropriate category structure, for example, the entity word 341 belongs to the leaf level in its corresponding category. Each entity word has its corresponding time information. Each entity word has its corresponding word state, for example, the entity word 341 is currently under review. That is, whether the entity word 341 is currently added to the entity word library. Additionally, for each entity word, the user 110 (for example, a manager) may perform some operations, such as editing the entity word, making the entity word online or offline, deleting the entity word, and so on. In some embodiments, the user 110 (for example, the manager) may click an edit control corresponding to any entity word to edit information such as the category level, name and explanation information of the entity word.

In some embodiments, if the terminal device 120 receives a trigger from the user 110 (for example, a manager) on a newly added control 345, the terminal device 120 may present a configuration panel 351 for configuring an entity word. Based on a selection box 352 in the configuration panel 351, the manager may select a category level of the entity word to be added, such as a primary category, a secondary category, a leaf category and so on. Based on an input box 353 in the configuration panel 351, the manager may input a name of the entity word to be added. Based on an input box 354 in the configuration panel 351, the manager may input the explanation information of the entity word to be added. Further, the manager may add the entity word to the entity word library by clicking on a confirmation control 344. Therefore, based on the pre-built entity word library, the entity word in the auxiliary information related to the object may be quickly identified, so that the user may know the meaning of the entity word in time.

In some embodiments, the terminal device 120 may present a feedback control associated with the auxiliary information, and the user 110 may click on the feedback control to select or input feedback information for the auxiliary information, so as to determine the auxiliary information that better meets the needs of the user 110. How to obtain the feedback information will be described below with continued reference to FIGS. 2, 3A and 3C.

Continuing with the process 200, at block 215, the terminal device 120 may obtain feedback information from the user 110. Referring to the example interfaces 300A and 300C shown in FIGS. 3A and 3C, the terminal device 120 may present a feedback control 317 associated with the auxiliary information 313 in the predetermined area 312. Further, if the terminal device 120 detects a trigger on the feedback control 317, the terminal device 120 may present a panel 330. The terminal device 120 may present, in the panel 330, feedback items for the auxiliary information 313, such as a feedback item 331 (for example, "inaccurate description" or any other appropriate content), a feedback item 332 (for example, "description not related to the object 311" or any other appropriate content), a feedback item 333 (for example, "not the content I want to know" or any other appropriate content), and so on. In addition, the terminal device 120 may present a title 334 and the auxiliary information 313 in the panel 330. In some embodiments, the terminal device 120 may present, in the panel 330, prompt information 335 for prompting the user 110 to provide the feedback information, for example, "the auxiliary information is from the machine learning model, and feedback may be given if errors are found" or any other appropriate prompt information.

In some embodiments, the terminal device 120 may present an input control in the panel 330 for obtaining the feedback information for the auxiliary information 313. It would be appreciated that the input control may include, but is not limited to, an input box, a voice input control, and an upload control. In this way, the user 110 may be enabled to actively input more feedback information based on the input control. Further, based on the selection of some feedback items from the feedback items such as the feedback item 331, the feedback item 332, the feedback item 333, and so on, the terminal device 120 may determine the selected feedback items as the feedback information for the auxiliary information. In some examples, the user 110 may select the feedback item presented by the terminal device 120 or input the feedback information based on the input control presented by the terminal device 120. The terminal device 120 may present the updated auxiliary information based on the received feedback item selected by the user 110 or the feedback information input by the user 110.

In some embodiments, the auxiliary information may be updated based on the feedback information. That is, the terminal device 120 may return the feedback information obtained by the terminal device 120 to the machine learning model. The machine learning model may be adjusted based on the feedback information to output auxiliary information that better meets the needs of the user. As an example, if the feedback information indicates positive feedback, the machine learning model may continue to generate auxiliary information similar to the auxiliary information. If the feedback information indicates negative feedback, the machine learning model may regenerate the auxiliary information. In this way, more suitable auxiliary information may be generated and presented for the user based on the user's feedback information.

In summary, the auxiliary information of the object may be obtained according to the present disclosure, thereby the richness of the information of the object may be improved. Further, by presenting the object information and the generated auxiliary information in the interface, the attention of the user may be attracted. In this way, the user may know the object more comprehensively, and be promoted to perform the next operation related to the object. For example, in the link of purchasing the object, decision information may be added for the user. Accordingly, the user may be provided with a feedback entry for selecting or inputting the feedback information for the auxiliary information, so that the auxiliary information that better meets the needs of the user may be updated and presented based on the feedback information.

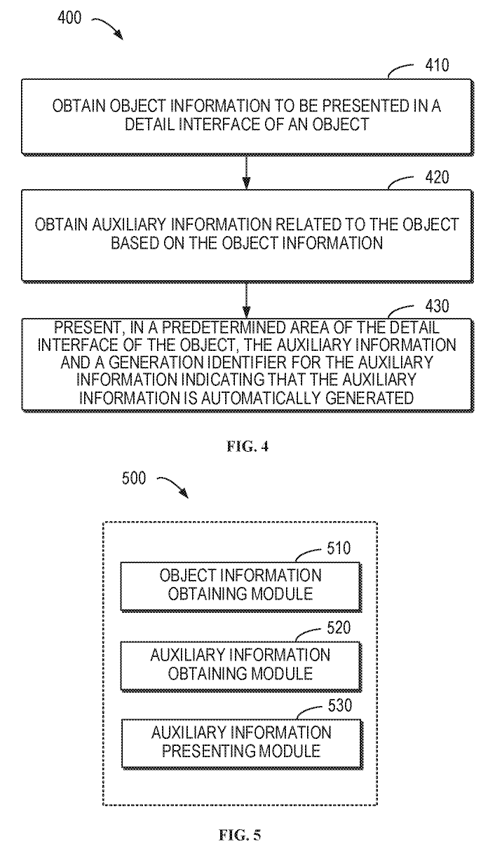

FIG. 4 illustrates a flowchart of a process 400 for information interaction according to some embodiments of the present disclosure. The process 400 may be implemented at the terminal device 120. The process 400 is described below with reference to FIG. 1.

At block 410, the terminal device 120 obtains object information to be presented in a detail interface of an object.

At block 420, the terminal device 120 obtains auxiliary information related to the object based on the object information.

At block 430, the terminal device 120 presents the auxiliary information and a generation identifier for the auxiliary information in a predetermined area of the detail interface of the object, the generation identifier indicating that the auxiliary information is automatically generated.

In some embodiments, the auxiliary information indicates encyclopedic content associated with the object.

In some embodiments, the auxiliary information is generated by: generating the auxiliary information based on the object information using a machine learning model.

In some embodiments, the auxiliary information includes at least an entity word associated with the object, and the process 400 further includes: presenting the entity word in the auxiliary information in a predetermined visual style, the predetermined visual style being different from a visual style of other parts of the auxiliary information; and presenting explanation information corresponding to the entity word in response to a trigger on the entity word.

In some embodiments, the predetermined visual style of the entity word includes a query identifier indicating that the entity word is queryable.

In some embodiments, presenting the explanation information of the entity word includes: presenting a first panel in an overlay manner in the detail interface, the first panel including the explanation information of the entity word.

In some embodiments, the entity word is determined by: determining the entity word included in the auxiliary information by comparing the auxiliary information with an entity word library, where the entity word library includes multiple predefined entity words and corresponding explanation information.

In some embodiments, the object information includes at least one of: a title of the object, an image of the object, a description text of the object, or attribute information of the object.

In some embodiments, the process 400 further includes: presenting a feedback control associated with the auxiliary information in the predetermined area; presenting a second panel in response to a trigger on the feedback control, the second panel including at least one feedback item for the auxiliary information; and determining one or more feedback items as feedback information for the auxiliary information in response to a selection of the one or more feedback items in the at least one feedback item.

In some embodiments, the auxiliary information related to the object is updated based at least on the feedback information.

In some embodiments, the second panel further includes at least one of: prompt information for prompting the user to provide the feedback information, or the auxiliary information.

The embodiments of the present disclosure further provide a corresponding apparatus for implementing the above method or process.

FIG. 5 illustrates a schematic structural block diagram of an apparatus 500 for information interaction according to some embodiments of the present disclosure. The apparatus 500 may be implemented as or included in the terminal device 120. Each module/component in the apparatus 500 may be implemented by hardware, software, firmware, or any combination thereof.

As shown in FIG. 5, the apparatus 500 includes an object information obtaining module 510 configured to obtain object information to be presented in a detail interface of an object. The apparatus 500 further includes an auxiliary information obtaining module 520 configured to obtain auxiliary information related to the object based on the object information. The apparatus 500 further includes an auxiliary information presenting module 530 configured to present, in a predetermined area of the detail interface of the object, the auxiliary information and a generation identifier for the auxiliary information indicating that the auxiliary information is automatically generated.

In some embodiments, the auxiliary information indicates encyclopedic content associated with the object.

In some embodiments, the auxiliary information is generated by: generating the auxiliary information based on the object information using a machine learning model.

In some embodiments, the auxiliary information includes at least an entity word associated with the object, and the apparatus 500 further includes an explanation information presenting module configured to present the entity word in the auxiliary information in a predetermined visual style, the predetermined visual style being different from a visual style of other parts of the auxiliary information; and present explanation information corresponding to the entity word in response to a trigger on the entity word.

In some embodiments, the predetermined visual style of the entity word includes a query identifier indicating that the entity word is queryable.

In some embodiments, the explanation information presenting module is further configured to present a first panel in an overlay manner in the detail interface, the first panel including the explanation information of the entity word.

In some embodiments, the entity word is determined by: determining the entity word included in the auxiliary information by comparing the auxiliary information with an entity word library, where the entity word library includes multiple predefined entity words and corresponding explanation information.

In some embodiments, the object information includes at least one of: a title of the object, an image of the object, a description text of the object, or attribute information of the object.

In some embodiments, the apparatus 500 further includes a feedback information determination module configured to present a feedback control associated with the auxiliary information in the predetermined area; present a second panel in response to a trigger on the feedback control, the second panel including at least one feedback item for the auxiliary information; and determine one or more feedback items as feedback information for the auxiliary information in response to a selection of the one or more feedback items in the at least one feedback item.

In some embodiments, the auxiliary information related to the object is updated based at least on the feedback information.

In some embodiments, the second panel further includes at least one of: prompt information for prompting the user to provide the feedback information, or the auxiliary information.

The units and/or modules included in the apparatus 500 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatus 500 may be implemented at least partially by one or more hardware logic components. As an example, rather than a limitation, example types of hardware logic components that may be used include field programmable gate array (FPGA), application specific integrated circuit (ASIC), application specific standard product (ASSP), system on chip (SOC), complex programmable logic device (CPLD), and so on.

It would be appreciated that one or more steps in the above method may be performed by a suitable electronic device or a combination of electronic devices. Such an electronic device or a combination of electronic devices may include, for example, the terminal device 120 and the server 130 in FIG. 1.

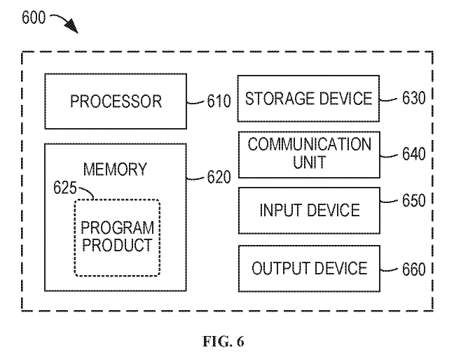

FIG. 6 illustrates a block diagram of an electronic device 600 in which one or more embodiments of the present disclosure may be implemented. It would be appreciated that the electronic device 600 shown in FIG. 6 is only illustrative and should not constitute any limitation on the functionality and scope of the embodiments described herein. The electronic device 600 shown in FIG. 6 may be used to implement the terminal device 120 or the server 130 in FIG. 1.

As shown in FIG. 6, the electronic device 600 is in the form of a general-purpose electronic device. The components of the electronic device 600 may include, but are not limited to, one or more processing units or processors 610, a memory 620, a storage device 630, one or more communication units 640, one or more input devices 650, and one or more output devices 660. The processing unit 610 may be an actual or virtual processor and may perform various processes based on the programs stored in the memory 620. In a multiprocessor system, multiple processing units execute computer-executable instructions in parallel to improve the parallel processing capability of the electronic device 600.

The electronic device 600 typically includes multiple computer storage media. Such medium may be any available medium accessible by the electronic device 600, including, but not limited to, volatile and non-volatile medium, removable and non-removable medium. The memory 620 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include other removable/non-removable, volatile/non-volatile memory medium. Although not shown in FIG. 6, it is possible to provide a disk driver for reading from or writing to a removable, non-volatile disk (such as a "floppy disk"), and an optical disk driver for reading from or writing to a removable, non-volatile optical disk. In these cases, each driver may be connected to the bus (not shown) via one or more data medium interfaces. The memory 620 may include a computer program product 625 having one or more program modules configured to perform various methods or acts of the various embodiments of the present disclosure.

The communication unit 640 enables communication with other electronic devices through the communication medium. Additionally, the functions of the components of the electronic device 600 may be implemented by a single computing cluster or multiple computing machines, which may communicate over communication connections. Therefore, the electronic device 600 may use a logical connection with one or more other servers, a network personal computer (PC) or another network node to operate in a networked environment.

The input device 650 may be one or more input devices, such as a mouse, a keyboard, a tracking ball, and so on. The output device 660 may be one or more output devices, such as a display, a speaker, a printer, and so on. The electronic device 600 may also communicate with one or more external devices (not shown) as needed via the communication unit 640, such as a storage device, a display device, etc., with one or more devices that enable the user to interact with the electronic device 600, or with any devices (for example, a network card, a modem, and so on) that enable the electronic device 600 to communicate with one or more other electronic devices. Such communication may be performed via input/output (I/O) interfaces (not shown).

According to an illustrative implementation of the present disclosure, there is provided a computer-readable storage medium having computer-executable instructions stored thereon, where the computer-executable instructions are executed by a processor to implement the method described above. According to an illustrative implementation of the present disclosure, there is further provided a computer program product tangibly stored on a non-transitory computer-readable medium and including computer-executable instructions, which are executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing the functions/acts specified in one or more blocks of the flowcharts and/or block diagrams is produced. These computer-readable program instructions may also be stored in a computer-readable storage medium, which instructions cause a computer, a programmable data processing apparatus, and/or other devices to work in a particular manner, so that the computer-readable medium having the instructions stored thereon includes an article of manufacture that includes instructions for implementing various aspects of the functions/acts specified in one or more blocks of the flowcharts and/or block diagrams.

The computer-readable program instructions may be loaded onto a computer, another programmable data processing apparatus, or other devices, so that a series of operating steps are performed on the computer, the other programmable data processing apparatus, or the other devices to produce a computer-implemented process, such that the instructions executed on the computer, the other programmable data processing apparatus, or the other devices implement the functions/acts specified in one or more blocks of the flowcharts and/or block diagrams.

The flowcharts and block diagrams in the drawings illustrate the possibly implemented architectures, functions, and operations of the systems, methods and computer program products according to multiple implementations of the present disclosure. In this regard, each block in the flowchart or block diagram may represent a module, a program segment, or a portion of instructions, which module, program segment, or portion of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block of the block diagrams and/or flowcharts, and combinations of the blocks in the block diagrams and/or flowcharts, may be implemented by a special-purpose hardware-based system that performs the specified functions or acts, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope and spirit of the described implementations. The choice of terms used herein is intended to best explain the principles of the implementations, the practical applications, or the improvements to the technologies in the market, or to enable other persons of ordinary skill in the art to understand the implementations disclosed herein.

1. A method for information interaction, comprising:
obtaining object information to be presented in a detail interface of an object;
obtaining auxiliary information related to the object based on the object information; and
presenting, in a predetermined area of the detail interface of the object, the auxiliary information and a generation identifier for the auxiliary information indicating that the auxiliary information is automatically generated.

2. The method of claim 1, wherein the auxiliary information indicates encyclopedic content associated with the object.

3. The method of claim 1, wherein the auxiliary information is generated by:
generating the auxiliary information based on the object information using a machine learning model.

4. The method of claim 1, wherein the auxiliary information comprises at least one entity word associated with the object, and the method further comprises:
presenting the entity word in the auxiliary information in a predetermined visual style, the predetermined visual style being different from a visual style of other parts of the auxiliary information; and
presenting, in response to a trigger on the entity word, explanation information corresponding to the entity word.

5. The method of claim 4, wherein the predetermined visual style of the entity word comprises a query identifier indicating that the entity word is queryable.

6. The method of claim 4, wherein presenting the explanation information of the entity word comprises:
presenting a first panel in an overlay manner in the detail interface, the first panel comprising the explanation information of the entity word.

7. The method of claim 4, wherein the entity word is determined by:
determining the entity word comprised in the auxiliary information by comparing the auxiliary information with an entity word library, wherein the entity word library comprises a plurality of predefined entity words and corresponding explanation information.

8. The method of claim 1, wherein the object information comprises at least one of:
a title of the object,
an image of the object,
a description text of the object, or
attribute information of the object.

9. The method of claim 1, further comprising:
presenting a feedback control associated with the auxiliary information in the predetermined area;
presenting, in response to a trigger on the feedback control, a second panel comprising at least one feedback item for the auxiliary information; and
determining, in response to a selection of one or more feedback items in the at least one feedback item, the one or more feedback items as feedback information for the auxiliary information.

10. The method of claim 9, wherein the auxiliary information related to the object is updated based at least on the feedback information.

11. The method of claim 9, wherein the second panel further comprises at least one of:
prompt information for prompting a user to provide feedback information, or
the auxiliary information.

12. An electronic device, comprising:
at least one processor; and
at least one memory coupled to the at least one processor and storing instructions executable by the at least one processor, the instructions, when executed by the at least one processor, cause the electronic device to perform operations comprising:
obtaining object information to be presented in a detail interface of an object;
obtaining auxiliary information related to the object based on the object information; and
presenting, in a predetermined area of the detail interface of the object, the auxiliary information and a generation identifier for the auxiliary information indicating that the auxiliary information is automatically generated.

13. The electronic device of claim 12, wherein the auxiliary information indicates encyclopedic content associated with the object.

14. The electronic device of claim 12, wherein the auxiliary information is generated by:
generating the auxiliary information based on the object information using a machine learning model.

15. The electronic device of claim 12, wherein the auxiliary information comprises at least one entity word associated with the object, and the operations further comprise:
presenting the entity word in the auxiliary information in a predetermined visual style, the predetermined visual style being different from a visual style of other parts of the auxiliary information; and
presenting, in response to a trigger on the entity word, explanation information corresponding to the entity word.

16. The electronic device of claim 15, wherein presenting the explanation information of the entity word comprises:
presenting a first panel in an overlay manner in the detail interface, the first panel comprising the explanation information of the entity word.

17. The electronic device of claim 12, wherein the object information comprises at least one of:
a title of the object,
an image of the object,
a description text of the object, or
attribute information of the object.

18. The electronic device of claim 12, the operations further comprise:
presenting a feedback control associated with the auxiliary information in the predetermined area;
presenting, in response to a trigger on the feedback control, a second panel comprising at least one feedback item for the auxiliary information; and
determining, in response to a selection of one or more feedback items in the at least one feedback item, the one or more feedback items as feedback information for the auxiliary information.

19. The electronic device of claim 18, wherein the second panel further comprises at least one of:
prompt information for prompting a user to provide feedback information, or
the auxiliary information.

20. A non-transitory computer-readable storage medium having computer-executable instructions stored thereon, the computer-executable instructions being executable by a processor to implement operations comprising:
obtaining object information to be presented in a detail interface of an object;
obtaining auxiliary information related to the object based on the object information; and
presenting, in a predetermined area of the detail interface of the object, the auxiliary information and a generation identifier for the auxiliary information indicating that the auxiliary information is automatically generated.
